(19) United States
(12) Patent Application Publication
(10) Pub. No.: US 2025/0216510 A1
(43) Pub. Date: Jul. 3, 2025

(54) DEVICE AND METHOD FOR SIMULATING AN RF REFLECTIVE OBJECT

(71) Applicant: Rohde & Schwarz GmbH & Co. KG, Munich (DE)

(72) Inventors: Thomas HABERL, Munich (DE); Maximilian SAALFELD, Munich (DE)

(21) Appl. No.: 18/403,300

(22) Filed: Jan. 3, 2024

(51) Int. Cl. G01S 7/40

(52) U.S. Cl. CPC G01S 7/4082

(57) ABSTRACT

Disclosed are a device and a method for simulating an RF reflective object, and a device for simulating RF fading. The device for simulating the RF reflective object comprises: a receiver or input, configured for receiving an RF signal from a device under test, DUT; a signal variation parameter estimation circuit, configured for estimating, based on an analysis of the RF signal, one or more signal variation-over-time parameters of the RF signal; one or more signal parameter adaptation circuits, configured for adapting one or more signal parameters of the RF signal in real-time as a function of one or more simulation parameters, and the one or more estimated signal variation-over-time parameters of the RF signal; and a transmitter, configured for transmitting the adapted RF signal to the DUT, the adapted RF signal simulating a reflection of the RF signal by the object or an RF fading of the RF signal. This provides automatic analysis of signal parameters and automatic adaptation of simulation parameters of objects which depend on the signal parameters and would have to be corrected manually otherwise.

### TECHNICAL FIELD

The present disclosure relates to radio detection and ranging (RADAR) echo generation, and in particular to devices and methods for simulating an RF reflective object and to devices for simulating RF fading.

### BACKGROUND ART

Radar sensors usually change their signal parameters during object detection depending on the current task in order to gain either improved range resolution or maximum visible distance.

Until now, the signal parameters such as a center frequency are pre-configured manually and the object resp. channel simulation has to be parametrized accordingly. Any deviations from the pre-configured signal parameters caused by a measurement setup or tolerances of the radar sensor device under test (DUT) require manual correction. This applies to simulation of RF reflective objects e.g. in front of the DUT as well as to simulation of RF fading in between a tester and the DUT.

### SUMMARY

It is an object to overcome the above-mentioned and other drawbacks.

The foregoing and other objects are achieved by the features of the independent claims. Further implementation forms are apparent from the dependent claims, the description and the figures.

According to a first aspect of the present disclosure, a device is provided for simulating an RF reflective object. The device comprises: a receiver, configured for receiving an RF signal from a device under test, DUT; a signal variation parameter estimation circuit, configured for estimating, based on an analysis of the RF signal, one or more signal variation-over-time parameters of the RF signal; one or more signal parameter adaptation circuits, configured for adapting one or more signal parameters of the RF signal in real-time as a function of one or more simulation parameters, and the one or more estimated signal variation-over-time parameters of the RF signal; and a transmitter, configured for transmitting the adapted RF signal to the DUT, the adapted RF signal simulating a reflection of the RF signal by the object.

According to a second aspect of the present disclosure, a device is provided for simulating RF fading. The device comprises: an input, configured for receiving an RF signal; a signal variation parameter estimation circuit, configured for estimating, based on an analysis of the RF signal, one or more signal variation-over-time parameters of the RF signal; one or more signal parameter adaptation circuits, configured for adapting one or more signal parameters of the RF signal in real-time as a function of one or more simulation parameters, and the one or more estimated signal variation-over-time parameters of the RF signal; and a transmitter, configured for transmitting the adapted RF signal to a device under test, DUT, the adapted RF signal simulating an RF fading of the RF signal.

The RF signal and the adapted RF signal may be radar signals.

The signal parameters of the RF signal may comprise one or more of: a timing of the RF signal, a frequency of the RF signal, and an average power of the RF signal.

The estimated signal variation-over-time parameters of the RF signal may comprise an estimated frequency offset of the RF signal.

The signal parameter adaptation circuits may respectively be configured for adapting one of the signal parameters of the RF signal.

The simulation parameters may comprise one or more of: a delay of the object in accordance with a simulated radial distance of the object relative to the DUT, a frequency shift of the object in accordance with a simulated radial velocity of the object relative to the DUT, and an attenuation of the object in accordance with a simulated cross-sectional area of the object and the simulated radial distance of the object relative to the DUT.

The simulation parameters may further comprise one of: a zero-mean Gaussian random path attenuation between the object and the DUT, and a power delay profile comprising attenuation values and delay values for a plurality of taps of a tapped delay line fading model.

The signal parameter adaptation circuits may comprise one or more of: a tunable delay circuit for delaying the RF signal in accordance with the delay of the object, a tunable frequency shift circuit for shifting the frequency of the RF signal in accordance with the frequency shift of the object and the estimated frequency offset of the RF signal, and a tunable attenuation circuit for attenuating the RF signal in accordance with the attenuation of the object.

The signal parameter adaptation circuits may further comprise one of: a fading emulation circuit for attenuating the RF signal in accordance with the zero-mean Gaussian random path attenuation, and a fading emulation circuit for attenuating and delaying the RF signal in accordance with the power delay profile.

The device may further comprise a user notification circuit for notifying a user of the device of the estimated signal variation-over-time parameters of the RF signal relative to corresponding user-provided signal parameters of the RF signal.

According to a third aspect of the present disclosure, a measurement system is provided, comprising a device for simulating an RF reflective object according to the first aspect or a device for simulating RF fading according to the second aspect; and a device under test, DUT, being a radar sensor preferably for automotive applications.

According to a fourth aspect of the present disclosure, a method is provided for simulating an RF reflective object. The method comprises: receiving an RF signal from a device under test, DUT; estimating, based on an analysis of the RF signal, one or more signal variation-over-time parameters of the RF signal; adapting one or more signal parameters of the RF signal in real-time as a function of one or more simulation parameters and the one or more estimated signal variation-over-time parameters of the RF signal; and transmitting the adapted RF signal to the DUT, the adapted RF signal simulating a reflection of the RF signal by the object.

The method may be performed by a device for simulating an RF reflective object according to the first aspect.

### ADVANTAGEOUS EFFECTS

The present disclosure provides automatic analysis of signal parameters and automatic adaptation of simulation parameters of objects which depend on the signal parameters and would have to be corrected manually otherwise.

### BRIEF DESCRIPTION OF DRAWINGS

The above-described aspects and implementations will now be explained with reference to the accompanying drawings, in which the same or similar reference numerals designate the same or similar elements.

The features of these aspects and implementations may be combined with each other unless specifically stated otherwise.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a measurement system including a device in accordance with the present disclosure; and

FIG. 2 illustrates a method in accordance with the present disclosure.

### DETAILED DESCRIPTIONS OF DRAWINGS

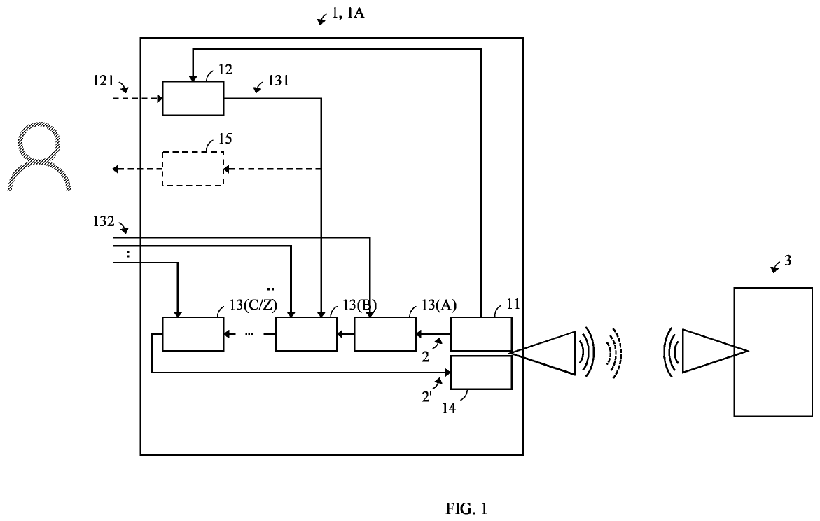

FIG. 1 illustrates a measurement system 1, 1A, 3 including a device 1, 1A in accordance with the present disclosure.

The measurement system 1, 1A, 3 comprises a device 1 for simulating an RF reflective object according to the first aspect or a device 1A for simulating RF fading according to the second aspect, and a device under test, DUT 3. The DUT 3 may be a radar sensor, preferably for automotive applications.

The device 1, 1A comprises a receiver or input 11, a signal variation parameter estimation circuit 12, one or more signal parameter adaptation circuits 13, 13A-Z, a transmitter 14, and may comprise a user notification circuit 15.

The receiver 11 is configured for receiving an RF signal 2, preferably from a device under test, DUT 3 or the input 11 is configured for receiving an RF signal 2, preferably from an RF source such as an RF vector signal generator. In particular, the RF signal 2 may be a radar signal. Likewise, the receiver 11 may comprise a radar receiver.

The signal variation parameter estimation circuit 12 is configured for estimating, based on an analysis of the RF signal 2, one or more signal variation-over-time parameters 131 of the RF signal 2.

In particular, the estimated signal variation-over-time parameters 131 of the RF signal 2 may comprise an estimated frequency offset Δf of the RF signal 2, either relative to the (given) frequency f₀ of the RF signal 2 (i.e., Δf) or implicitly (i.e., f₀+Δf). Correspondingly, the signal variation parameter estimation circuit 12 may, for instance, comprise an analog-to-digital converter, ADC, a digital down converter, DDC, and a Fast Fourier Transform, FFT, analyzer implemented as a digital circuit (e.g., ASIC, FPGA, DSP or the like).

The one or more signal parameter adaptation circuits 13, 13A-Z are configured for adapting one or more signal parameters of the RF signal 2 in real-time as a function of one or more simulation parameters 132 and the one or more estimated signal variation-over-time parameters 131 of the RF signal 2.

The signal parameters of the RF signal 2 may comprise one or more of: a timing of the RF signal 2, a frequency f₀ of the RF signal 2, and an average power of the RF signal 2.

A timing as used herein may refer to a temporal occurrence (e.g., start time, end time) of a pulse of the RF signal 2.

A power as used herein may refer to an average power (in mW) or power level (in dBm, with reference to 1 mW) of the RF signal 2.

A frequency as used herein may refer to a center frequency f₀ of the RF signal 2.

The simulation parameters 132 may comprise one or more of: a delay Δt of the object in accordance with a simulated radial distance r of the object relative to the DUT 3, a frequency shift Δf_{D} of the object in accordance with a simulated radial velocity v of the object relative to the DUT 3 (i.e., a Doppler frequency shift), and an attenuation a of the object in accordance with a simulated cross-sectional area σ of the object—i.e., a radar cross-section, RCS—and the simulated radial distance r of the object relative to the DUT 3. The simulation parameters 132 may further comprise one of a zero-mean Gaussian random path attenuation ε between the object and the DUT 3, and a power delay profile comprising attenuation values aᵢ and delay values τᵢ for a plurality of i taps of a tapped delay line fading model.

$$\begin{matrix}Δ t = 2 {rc}_{0} & ⇒ Δ t \sim r \\ Δ {f}_{D} \approx {f}_{0} \frac{2 v}{{c}_{0}} & ⇒ Δ {f}_{D} \sim v {f}_{0} \\ α = \frac{{P}_{Rx}}{{P}_{Tx}} = {G}_{Tx} \frac{1}{4 π {r}^{2}} σ \frac{1}{4 π {r}^{2}} {A}_{eff , Rx} & ⇒ α \sim \frac{σ}{{r}^{4}} \\ {α}^{′} = \frac{{P}_{Rx}}{{P}_{Tx}} = {G}_{Tx} \frac{1}{4 π {r}^{2}} εσε \frac{1}{4 π {r}^{2}} {A}_{eff , Rx} & ⇒ {( \frac{α′}{α} \sim ε )}^{2}\end{matrix}$$

More specifically, the signal parameter adaptation circuits 13, 13A-Z may comprise one or more of: a tunable delay circuit 13A (e.g., analog tunable delay line or equivalent DSP filter implementation) for delaying the RF signal 2 in accordance with the delay Δt of the object, a tunable frequency shift circuit 13B (e.g., analog complex frequency shifter, or equivalent DSP filter implementation) for shifting the frequency f₀ of the RF signal 2 in accordance with the frequency shift Δf_{D} of the object and the estimated frequency offset Δf of the RF signal 2, and a tunable attenuation circuit 13Z (e.g., analog variable attenuator, or equivalent DSP filter implementation) for attenuating the RF signal 2 in accordance with the attenuation a of the object. The signal parameter adaptation circuits 13, 13A-Z may further comprise one of: a fading emulation circuit 13C (e.g., a DSP filter implementation) for attenuating the RF signal 2 in accordance with the zero-mean Gaussian random path attenuation ε, and a fading emulation circuit 13C (e.g., a DSP filter implementation) for attenuating and delaying the RF signal 2 in accordance with the power delay profile.

Shifting the frequency f₀→f₀+Δf of the RF signal 2 in accordance with the frequency shift Δf_{D} (due to the simulated radial velocity v) of the object and the estimated frequency offset Δf of the RF signal 2 may be outlined as follows:

$$Δ {f}_{D}^{′} \approx {f}_{0}^{′} \frac{2 v}{{c}_{0}} = ( {f}_{0} + Δ f ) \frac{2 v}{{c}_{0}} = Δ {f}_{D} + Δ f \frac{2 v}{{c}_{0}}$$

In other words, the estimated frequency offset Δf of the frequency f₀ of the RF signal 2 yields a corresponding offset

$$Δ f \frac{2 v}{{c}_{0}}$$

of the frequency shift Δf_{D} of the object. Said corresponding offset can be taken into account automatically by the tunable frequency shift circuit 13B, besides the frequency shift Δf_{D} of the object (at frequency f₀).

The transmitter 14 is configured for transmitting the adapted RF signal 2′ to the DUT 3, wherein the adapted RF signal 2′ simulates a reflection of the RF signal 2 by the object or an RF fading of the RF signal 2.

Evidently, the adapted RF signal 2′ may be a radar signal, too. Accordingly, the transmitter 14 may comprise a radar transmitter.

The receiver 11 and the transmitter 12 may form part of a transceiver 11, 12 being connected to an antenna (shown as triangular shape in FIG. 1) mediating between wireline transmission and wireless transmission of the RF signals 2, 2′.

The user notification circuit 15, if any, is configured for notifying a user of the device 1, 1A of the estimated signal variation-over-time parameters 131 of the RF signal 2 relative to corresponding user-provided signal parameters 121 of the RF signal 2. In other words, the signal variation-over-time parameters 131 of the RF signal 2 may be used to distinguish between the wanted RF signal and interferers.

Also the user-provided signal parameters 121 of the RF signal 2 may comprise one or more of: a timing of the RF signal 2, a frequency f₀ of the RF signal 2, and an average power of the RF signal 2.

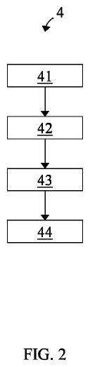

FIG. 2 illustrates a method 4 in accordance with the present disclosure.

The method 4 is suitable for simulating an RF reflective object.

The method 4 comprises a step of receiving 41 an RF signal 2 from a device under test, DUT 3.

The method 4 further comprises a step of estimating 42, based on an analysis of the RF signal 2, one or more signal variation-over-time parameters 131 of the RF signal 2.

The method 4 further comprises a step of adapting 43 one or more signal parameters of the RF signal 2 in real-time as a function of one or more simulation parameters 132 and the one or more estimated signal variation-over-time parameters 131 of the RF signal 2.

The method 4 further comprises a step of transmitting 44 the adapted RF signal 2′ to the DUT 3, the adapted RF signal 2′ simulating a reflection of the RF signal 2 by the object.

The method 4 may be performed by a device 1 for simulating an RF reflective object according to the first aspect.

The technical effects and advantages described above in relation with the device 1 of the first aspect equally apply to the method 4 of the third aspect having corresponding features.

1. A device for simulating a radio frequency (RF) reflective object, the device comprising
a receiver, configured for receiving an RF signal from a device under test (DUT);
a signal variation parameter estimation circuit, configured for estimating, based on an analysis of the RF signal, one or more signal variation-over-time parameters of the RF signal;
one or more signal parameter adaptation circuits, configured for adapting one or more signal parameters of the RF signal in real-time as a function of one or more simulation parameters, and the one or more estimated signal variation-over-time parameters of the RF signal; and
a transmitter, configured for transmitting the adapted RF signal to the DUT, the adapted RF signal simulating a reflection of the RF signal by the object.

2. The device of claim 1,
the RF signal and the adapted RF signal being radar signals.

3. The device of claim 1,
the signal parameters of the RF signal comprising one or more of:
a timing of the RF signal,
a frequency of the RF signal, and
an average power of the RF signal.

4. The device of claim 1,
the estimated signal variation-over-time parameters of the RF signal comprising:
an estimated frequency offset of the RF signal.

5. The device of claim 1,
the signal parameter adaptation circuits respectively being configured for adapting one of the signal parameters of the RF signal.

6. The device of claim 1,
the simulation parameters comprising one or more of:
a delay of the object in accordance with a simulated radial distance of the object relative to the DUT,
a frequency shift of the object in accordance with a simulated radial velocity of the object relative to the DUT, and
an attenuation of the object in accordance with a simulated cross-sectional area of the object and the simulated radial distance of the object relative to the DUT.

7. The device of claim 6,
the simulation parameters further comprising one of:
a zero-mean Gaussian random path attenuation between the object and the DUT, and
a power delay profile comprising attenuation values and delay values for a plurality of taps of a tapped delay line fading model.

8. The device of claim 6,
the signal parameter adaptation circuits comprising one or more of:
a tunable delay circuit for delaying the RF signal in accordance with the delay of the object,
a tunable frequency shift circuit for shifting the frequency of the RF signal in accordance with the frequency shift of the object and the estimated frequency offset of the RF signal, and
a tunable attenuation circuit for attenuating the RF signal in accordance with the attenuation of the object.

9. The device of claim 7,
the signal parameter adaptation circuits further comprising one of:
a fading emulation circuit for attenuating the RF signal in accordance with the zero-mean Gaussian random path attenuation, and
a fading emulation circuit for attenuating and delaying the RF signal in accordance with the power delay profile.

10. The device of claim 1, further comprising
a user notification circuit for notifying a user of the device of the estimated signal variation-over-time parameters of the RF signal relative to corresponding user-provided signal parameters of the RF signal.

11. A measurement system, comprising
a device
for simulating a radio frequency (RF) reflective object comprising:
a receiver, configured for receiving an RF signal from a device under test (DUT),
a signal variation parameter estimation circuit, configured for estimating, based on an analysis of the RF signal, one or more signal variation-over-time parameters of the RF signal,
one or more signal parameter adaptation circuits, configured for adapting one or more signal parameters of the RF signal in real-time as a function of one or more simulation parameters, and the one or more estimated signal variation-over-time parameters of the RF signal, and
a transmitter, configured for transmitting the adapted RF signal to the DUT, the adapted RF signal simulating a reflection of the RF signal by the object; or
for simulating an RF fading comprising:
an input, configured for receiving another RF signal;
a signal variation parameter estimation circuit, configured for estimating, based on an analysis of the another RF signal, one or more signal variation-over-time parameters of the another RF signal;
one or more signal parameter adaptation circuits, configured for adapting one or more signal parameters of the another RF signal in real-time as a function of one or more simulation parameters, and the one or more estimated signal variation-over-time parameters of the another RF signal; and
a transmitter, configured for transmitting the adapted another RF signal to the DUT, the adapted another RF signal simulating the RF fading of the another RF signal; and
the DUT being a radar sensor preferably for automotive applications.

12. A method for simulating radio frequency (RF) reflective object, the method comprising
receiving an RF signal from a device under test (DUT);
estimating, based on an analysis of the RF signal, one or more signal variation-over-time parameters of the RF signal;
adapting one or more signal parameters of the RF signal in real-time as a function of one or more simulation parameters and the one or more estimated signal variation-over-time parameters of the RF signal; and
transmitting the adapted RF signal to the DUT, the adapted RF signal simulating a reflection of the RF signal by the object.

13. The method of claim 12,
being performed by a device for simulating an RF reflective object comprising:
a receiver;
a signal variation parameter estimation circuit;
one or more signal parameter adaptation circuits; and
a transmitter.

14. A device for simulating radio frequency (RF) fading, the device comprising
an input, configured for receiving an RF signal;
a signal variation parameter estimation circuit, configured for estimating, based on an analysis of the RF signal, one or more signal variation-over-time parameters of the RF signal;
one or more signal parameter adaptation circuits, configured for adapting one or more signal parameters of the RF signal in real-time as a function of one or more simulation parameters, and the one or more estimated signal variation-over-time parameters of the RF signal; and
a transmitter, configured for transmitting the adapted RF signal to a Device Under Test (DUT), the adapted RF signal simulating an RF fading of the RF signal.

15. The device of claim 14,
the RF signal and the adapted RF signal being radar signals.

16. The device of claim 14,
the signal parameters of the RF signal comprising one or more of:
a timing of the RF signal,
a frequency of the RF signal, and
an average power of the RF signal.

17. The device of claim 14,
the estimated signal variation-over-time parameters of the RF signal comprising:
an estimated frequency offset of the RF signal.

18. The device of claim 14,
the signal parameter adaptation circuits respectively being configured for adapting one of the signal parameters of the RF signal.

19. The device of claim 14,
the simulation parameters comprising one or more of:
a delay of the object in accordance with a simulated radial distance of the object relative to the DUT,
a frequency shift of the object in accordance with a simulated radial velocity of the object relative to the DUT, and
an attenuation of the object in accordance with a simulated cross-sectional area of the object and the simulated radial distance of the object relative to the DUT.

20. The device of claim 17,
the simulation parameters further comprising one of:
a zero-mean Gaussian random path attenuation between the object and the DUT, and
a power delay profile comprising attenuation values and delay values for a plurality of taps of a tapped delay line fading model.
